(19) United States
(12) Patent Application Publication
(10) Pub. No.: US 2012/0119527 A1
(43) Pub. Date: May 17, 2012

(54) BARBEQUE GRILLING UTENSIL

(76) Inventors: Jeffery Dale Deitemeyer, Fort Collins, CO (US); Rosario Biunno, Casirate D\'adda (IT)

(21) Appl. No.: 13/294,508

(22) Filed: Nov. 11, 2011

Related U.S. Application Data
(60) Provisional application No. 61/413,032, filed on Nov. 12, 2010.

(51) Int. Cl. A47J 43/28

(52) U.S. Cl. 294/7

(57) ABSTRACT

The present invention is a barbeque grilling utensil that includes a shaft body, an internal shaft that is placed internally within the shaft body, an L-shaped actuation lever to movably secure the actuation lever to the shaft body and a spatula portion that is disposed on the shaft body that is controlled by the actuation lever. The barbeque grilling utensil also includes a handle that is disposed on the shaft body and is squeezed together with the actuation lever to control and operate the spatula portion, an internal spring that is integral to the pin to pivot joint and a pair of serrated contact blades that are disposed on one or more sides of the spatula portion that is integral to the pin to pivot joint.

This application claims priority to U.S. Provisional Application 61/413,032 filed on Nov. 12, 2010, the entire disclosure of which is incorporated by reference.

### TECHNICAL FIELD & BACKGROUND

The present invention generally relates to a cooking utensil. More specifically, the invention is a barbeque grilling utensil.

It is an object of the invention to provide a barbeque grilling utensil that relatively more easily allows a user to hold, lift and turn one or more foods grilled on a barbeque.

It is an object of the invention to provide a barbeque grilling utensil that is ergonomically designed to accommodate right and left handed individuals.

It is an object of the invention to provide a barbeque grilling utensil that utilizes an actuation mechanism with one or more serrated contact blades to allow a user to cut as well as hold, lift and turn one or more foods grilled on a barbeque or other suitable cooking surface.

What is really needed is a barbeque grilling utensil that relatively more easily allows a user to hold, lift and turn one or more foods grilled on a barbeque that is ergonomically designed to accommodate right and left handed individuals that utilizes an actuation mechanism with one or more serrated contact blades to allow a user to cut as well as hold, lift and turn one or more foods grilled on a barbeque or other suitable cooking surface.

### BRIEF DESCRIPTION OF THE DRAWINGS

The present invention will be described by way of exemplary embodiments, but not limitations, illustrated in the accompanying drawings in which like references denote similar elements, and in which:

FIG. 1A illustrates a top perspective view of a barbeque grilling utensil, in accordance with one embodiment of the present invention.

FIG. 1B illustrates an exploded side perspective view of a barbeque grilling utensil, in accordance with one embodiment of the present invention.

### DETAILED DESCRIPTION OF ILLUSTRATIVE EMBODIMENTS

Various aspects of the illustrative embodiments will be described using terms commonly employed by those skilled in the art to convey the substance of their work to others skilled in the art. However, it will be apparent to those skilled in the art that the present invention may be practiced with only some of the described aspects. For purposes of explanation, specific numbers, materials and configurations are set forth in order to provide a thorough understanding of the illustrative embodiments. However, it will be apparent to one skilled in the art that the present invention may be practiced without the specific details. In other instances, well-known features are omitted or simplified in order not to obscure the illustrative embodiments.

Various operations will be described as multiple discrete operations, in turn, in a manner that is most helpful in understanding the present invention. However, the order of description should not be construed as to imply that these operations are necessarily order dependent. In particular, these operations need not be performed in the order of presentation.

The phrase “in one embodiment” is used repeatedly. The phrase generally does not refer to the same embodiment, however, it may. The terms “comprising”, “having” and “including” are synonymous, unless the context dictates otherwise.

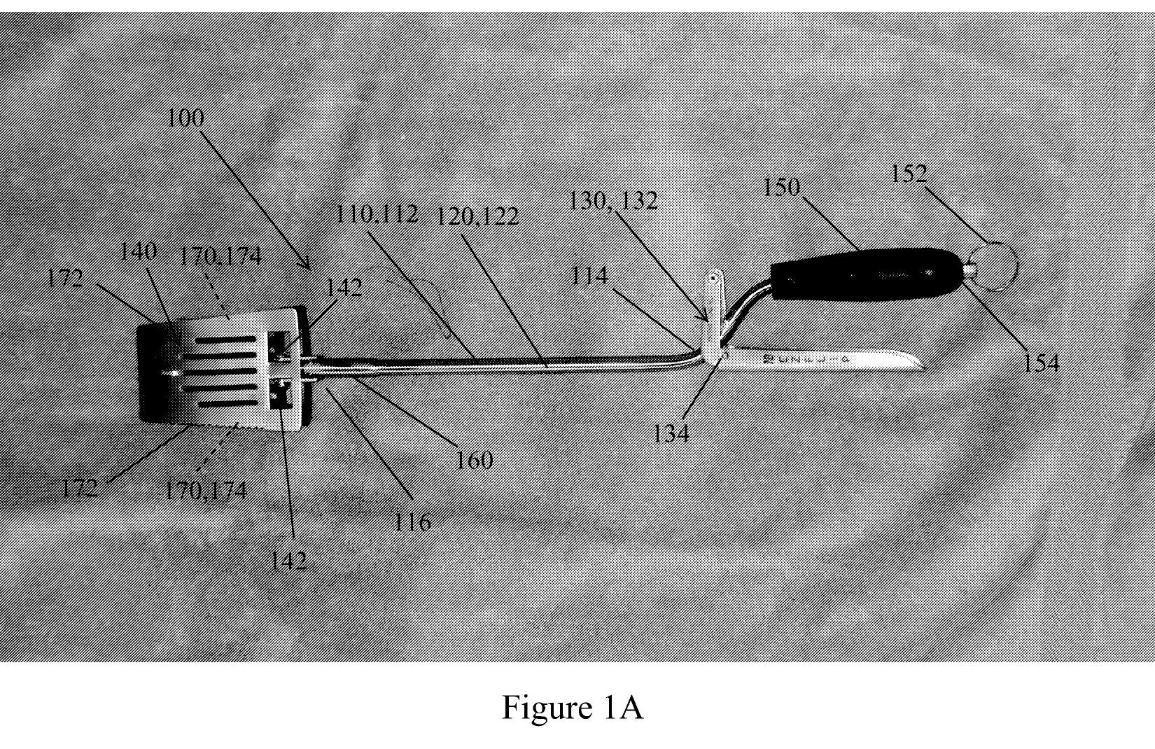

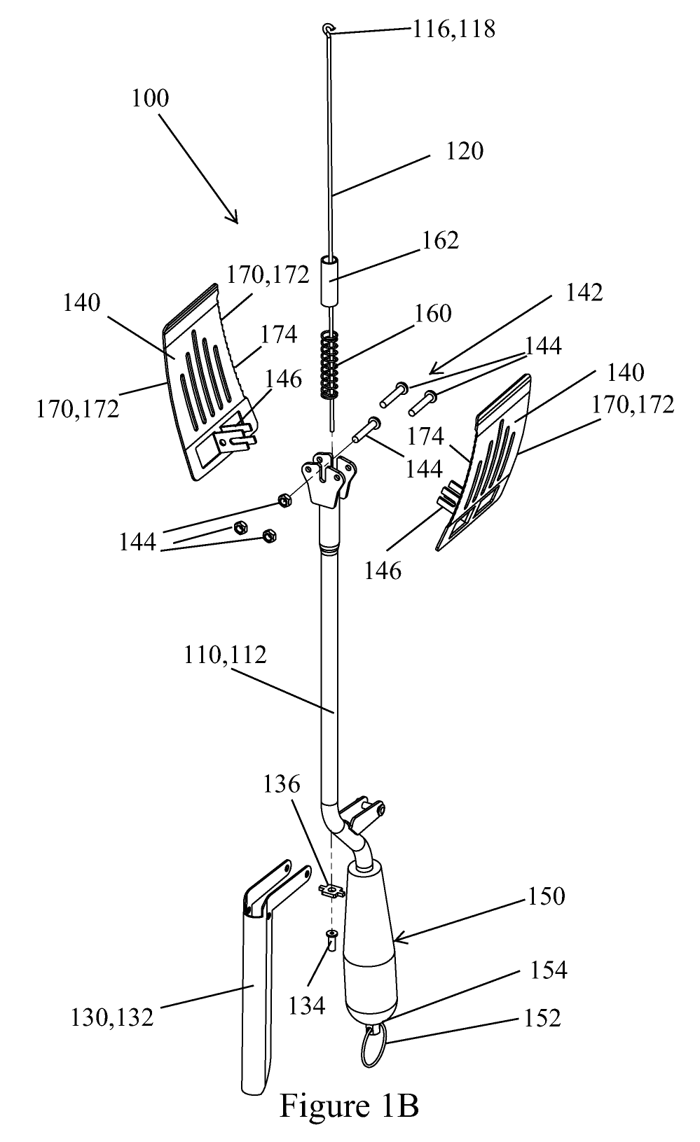

FIG. 1A illustrates a top perspective view of a barbeque grilling utensil 100, in accordance with one embodiment of the present invention.

The barbeque grilling utensil 100 includes a shaft body 110, an internal shaft 120, an actuation lever 130, a spatula portion 140, a handle 150, an internal spring 160 and a pair of contact blades 170.

The shaft body 110 has a proximal end 114 and a distal end 116 and is an elongated tubular shaft 112 although the shaft body could be any suitable shape. The shaft body 110 is made of metal, although the shaft body 110 can be made of any suitable material. The internal shaft 120 is set internally within the shaft body 110 and moves within the shaft body 110 to control other components of the barbeque grilling utensil 100. The internal shaft 120 is also an elongated tubular shaft 122 that could be any suitable shape and is made of metal although the elongated tubular shaft 122 can be made of any other suitable material. The actuation lever 130 is L-shaped 132 and is disposed on the proximal end 114 of the shaft body 110 and includes a rivet 134 and a horizontally protruding nut 136 to movably secure the actuation lever 130 to the proximal end 114 of the shaft body 110. The actuation lever 130 is integral with the internal shaft 120 and can be squeezed against the handle 150 to control and operate the spatula portion 140. The spatula portion 140 is disposed on the distal end 116 of the shaft body 110 and is controlled by the actuation lever 130 and internal shaft 120 that is integral to a pin to pivot joint 142 that is integral to the spatula portion 140. The handle 150 is also disposed on the proximal end 114 of the shaft body 110 and is squeezed together with the actuation lever 130 to control and operate the spatula portion 140. The handle 150 is also ergonomically designed to provide a relatively more comfortable grip and can be made of any suitable materials such as plastic. There is also an optional hanging ring 152 disposed typically on the end 154 of the handle 150 to accommodate a hook or other hanging device (not shown) to hang the barbeque grilling utensil 100. The internal spring 160 is disposed in front of the pin to pivot joint 142 and is integral to the pin to pivot joint 142 that is controlled by the handle 150 and the actuation lever 130. The pair of contact blades 170 are disposed on one or more sides 172 of the spatula portion 140 that can be utilized to cut one or more foods grilled on a barbeque or other suitable cooking surface that is integral to the pin to pivot joint 142. The contact blades 170 can be serrated 174 and are squeezed to close the contact blades 170 together movably disposed on the spatula portion 140 together, making holding, lifting and turning foods relatively easier by being controlled and operated by the handle 150, the actuation lever 130 and the pin to pivot joint 142.

FIG. 1B illustrates an exploded side perspective view of a barbeque grilling utensil 100, in accordance with one embodiment of the present invention. FIG. 1B includes all of the same components illustrated in FIG. 1A such as the shaft body 110, the internal shaft 120, the actuation lever 130, the spatula portion 140, the handle 150, the internal spring 160 and the pair of contact blades 170.

The spatula portion 140 is disposed on the distal end 116 of the shaft body 110 and is controlled by the actuation lever 130 and internal shaft 120 that is integral to a pin to pivot joint 142 that is integral to the spatula portion 140. The pin to pivot joint 142 specifically includes 3 bolts and 3 corresponding nuts 144 that intersect a pair of horizontally protruding slots 146 that movably secure the spatula portion 140 to the distal end 116 of the shaft body 110. The internal spring 160 is also protected and covered with a sheath 162. A hook 118 can also be disposed on the distal end 116 of the shaft body 110 to allow a user to hang the barbeque grilling utensil 100 from an exterior hanging device.

The present invention is a barbeque tool used for holding, lifting and turning foods. The present invention is designed to be used by right or left handed individuals by squeezing the actuating lever that closes the end blades disposed on the spatula together. The present invention is a barbeque tool that makes handling foods easier and has incorporated a mechanism that actuates the end blades on the spatula. The actuation is via the actuation lever on the shaft of the present invention. The barbeque grilling utensil is user friendly and ergonomically designed to accommodate right and left handed individuals. In addition, the blades have serrations for cutting foods with the actuation of the blades via the actuation lever on the shaft of the barbeque grilling utensil near the handle. The actuation lever is depressed or squeezed and pulls the actuation shaft down to close the blades together, making holding, lifting and turning foods relatively easier.

While the present invention has been related in terms of the foregoing embodiments, those skilled in the art will recognize that the invention is not limited to the embodiments described. The present invention can be practiced with modification and alteration within the spirit and scope of the appended claims. Thus, the description is to be regarded as illustrative instead of restrictive on the present invention.

What is claimed is:

1. A barbeque grilling utensil, comprising:
a shaft body with a proximal end and a distal end;
an internal shaft that is placed internally within said shaft body and moves within said shaft body to control said barbeque grilling utensil;
an actuation lever is disposed on said proximal end of said shaft body and includes a rivet and a horizontally protruding nut to movably secure said actuation lever to said proximal end of said shaft body;
a spatula portion that is disposed on said distal end of said shaft body and is controlled by said actuation lever and said internal shaft that is integral to a pin to pivot joint that is integral to said spatula portion;
a handle that is disposed on said proximal end of said shaft body and is squeezed together with said actuation lever to control and operate said spatula portion;
an internal spring that is disposed in front of said pin to pivot joint and is integral to said pin to pivot joint that is controlled by said handle and said actuation lever; and
a pair of contact blades that are disposed on one or more sides of said spatula portion that are utilized to cut one or more foods grilled on a barbeque or other suitable cooking surface that is integral to said pin to pivot joint.

2. The utensil according to claim 1, wherein said shaft body is an elongated tubular shaft.

3. The utensil according to claim 2, wherein said shaft body is made of metal.

4. The utensil according to claim 1, wherein said internal shaft is an elongated tubular shaft.

5. The utensil according to claim 4, wherein said elongated tubular shaft is made of metal.

6. The utensil according to claim 1, wherein said actuation lever is L-shaped.

7. The utensil according to claim 6, wherein said actuation lever is integral with said internal shaft and is squeezed against said handle to control and operate said spatula portion.

8. The utensil according to claim 1, wherein said handle is ergonomically designed to provide a comfortable grip and is made of plastic.

9. The utensil according to claim 1, wherein said contact blades are squeezed to close said contact blades together movably disposed on said spatula portion together.

10. The utensil according to claim 1, wherein said barbeque grilling utensil is holding, lifting and turning said foods by being controlled and operated by said handle, said actuation lever and said pin to pivot joint.

11. A barbeque grilling utensil, comprising:
a shaft body with a proximal end and a distal end;
an internal shaft that is placed internally within said shaft body and moves within said shaft body to control said barbeque grilling utensil;
an L-shaped actuation lever is disposed on said proximal end of said shaft body and includes a pair of rivet and a horizontally protruding nut to movably secure said actuation lever to said proximal end of said shaft body;
a spatula portion that is disposed on said distal end of said shaft body and is controlled by said actuation lever and said internal shaft that is integral to a pin to pivot joint that is integral to said spatula portion;
a handle that is disposed on said proximal end of said shaft body and is squeezed together with said actuation lever to control and operate said spatula portion;
an internal spring that is disposed in front of said pin to pivot joint and is integral to said pin to pivot joint that is controlled by said handle and said actuation lever; and
a pair of serrated contact blades that are disposed on one or more sides of said spatula portion that are utilized to cut one or more foods grilled on a barbeque or other suitable cooking surface that is integral to said pin to pivot joint.

12. The utensil according to claim 11, wherein said shaft body is an elongated tubular shaft.

13. The utensil according to claim 12, wherein said shaft body is made of metal.

14. The utensil according to claim 11, wherein said internal shaft is an elongated tubular shaft.

15. The utensil according to claim 11, wherein said elongated tubular shaft is made of metal.

16. The utensil according to claim 11, wherein said actuation lever is integral with said internal shaft and is squeezed against said handle to control and operate said spatula portion.

17. The utensil according to claim 11, wherein said handle is ergonomically designed to provide a comfortable grip and is made of as plastic.

18. The utensil according to claim 11, wherein said contact blades are squeezed to close said contact blades together movably disposed on said spatula portion together.

19. The utensil according to claim 11, wherein said barbeque grilling utensil is holding, lifting and turning said foods by being controlled and operated by said handle, said actuation lever and said pin to pivot joint.

20. The utensil according to claim 11, wherein said handle includes a hanging ring disposed on said handle.
